(19) United States
(12) Patent Application Publication
(10) Pub. No.: US 2003/0131525 A1
(43) Pub. Date: Jul. 17, 2003

(54) SUCTION-INSECT CAPTURING DEVICE

(76) Inventor: Carlo Bertani, Montechiarugolo (Parma) (IT)

Correspondence Address: Robert F. I. Conte, LEE, MANN, SMITH, McWILLIAMS, SWEENEY & OHLSON, P.O. Box 2786, Chicago, IL, 60690-2786, US

(21) Appl. No.: 10/068,738

(22) Filed: Feb. 6, 2002

(30) Foreign Application Priority Data
Jan. 11, 2002 (IT) MI2002A000047

(51) Int. Cl. A01M 1/08; A01M 1/06; A01M 5/08

(52) U.S. Cl. 43/139

(57) ABSTRACT

A fan for suction insect-capturing devices comprises at least one blade (9) extending radially away from a hub (10) mountable on a rotating shaft (6) of a suction insect-capturing device (1), to rotate about a rotation axis (X) which is coincident with the hub axis, and defines at least one setting angle (β) relative to a plane perpendicular to the rotation axis (X). The blade (9) has a leading flap (La) angularly offset at least at a radially external portion (11), in the rotation direction of the fan (Y), relative to radial directions (D) extending from the rotation axis (X) and intersecting said leading flap (La).

### BACKGROUND OF THE INVENTION

1. Field of the Invention

The present invention relates to a fan for suction insect-capturing devices comprising at least one blade extending radially away from a hub mountable on a rotation shaft of a suction insect-capturing device, to rotate about a rotation axis coincident with the hub axis, and defining at least one setting angle relative to a plane perpendicular to the rotation axis.

The invention also relates to a suction insect-capturing device comprising a sucking duct; a rotating shaft coaxially mounted in the sucking duct; a fan mounted on the shaft; a motor operatively connected to the shaft to keep the fan in rotation; a collecting vessel communicating with the sucking duct and located downstream of the fan.

2. Prior Art

It is known that suction insect-capturing devices are usable as an alternative to other electric-discharge devices or devices based on use of chemical substances, to eliminate insects such as mosquitoes, flies and the like with a weak impact on the ecosystem.

Such devices enable insects' entrapping without immediately killing them, so that those insects considered as “useful” such as bees can be released in those places where they do not cause trouble or harm.

Suction insect-capturing devices are known which comprise a tubular duct provided with a sucking fan inside it, said fan generating an air stream capable of carrying out sucking of the insects that, attracted by a light source or other call means, come close to the duct mouthpiece to be conveyed to and entrapped in a holding drawer located downstream of the fan.

The fan is provided with a plurality of blades usually consisting of flat laminae or thin plates of plastic material fitted on a hub at a given angle of incidence. The blades have rectilinear profiles of constant thickness the leading and trailing flaps of which are substantially parallel and can be possibly warped, following known aeronautics principles, to optimize the fan performance and maximize the air flow.

The known devices briefly described above however have some drawbacks.

In fact, even if most insects captured by the air flow pass through the region which is concern of the fan without impinging on it, some of them impact against the blades and bounce back. Following the impact, the insect is projected along a trajectory radially away from the rotation axis of the fan and can escape the suction action of the device and remain in the vicinity of the duct mouthpiece being stunned. In addition, due to the substantially rectangular plan shape of the blade and its sharp corners, the insect coming close to the blade end is likely to be squashed between the end edge of the blade and the inner surface of the duct, so that periodical interventions to clean the device are required.

In addition, fans made in accordance with the known art have scarcely deformable blades and therefore can cause injuries should the operator' hands accidentally come into contact with the running fan.

It should be also pointed out that, in order to ensure the maximum efficiency for the device, the fan must be maintained in rotation at a speed as much as possible close to a preset value, usually corresponding to the maximum speed allowable by regulations, with use of low-power motors. As a result, use of motors and apparatus for electric-power control made with particular care and accuracy are required, which will bring about an increase in the production costs.

In spite of the above, any oscillation in the power supplied to the shaft results in an uncontrolled variation in the fan speed that therefore can easily overcome the safety limits.

### SUMMARY OF THE INVENTION

The present invention aims at solving the problems found in the known art by proposing a fan for suction insect-capturing devices, the shape of which enables possible insects impacting thereon to be addressed to the duct centre so as to bring them in any case to a region where the air flow impinges on them in an efficient manner to suck them in.

It is a further aim of the present invention to devise a fan capable of reducing the risk of the insects being squashed against the duct walls.

It is another aim of the present invention to devise a fan that does not cause damage or injury to persons should they accidentally come into contact with it during running.

Finally, it is a further aim of the present invention to devise a fan capable of self-limiting the number of revolutions, should the power supplied to the shaft tend to increase beyond a preset value.

The foregoing and further aims that will become more apparent in the course of the following description, are substantially achieved by a fan for suction insect-capturing devices wherein said at least one blade has a leading flap angularly offset, at least at a radially external portion, in the rotation direction of the fan, relative to radial directions extending from the rotation axis and intersecting said leading flap.

It is also an object of the present invention to provide a device equipped with a fan in accordance with the invention as set out in claim 19.

### BRIEF DESCRIPTION OF THE DRAWINGS

Further features and advantages will best be understood from the detailed description of a preferred but not exclusive embodiment of a fan for suction insect-capturing devices and a device equipped with such a fan, in accordance with the present invention. This description will be made hereinafter with reference to the accompanying drawings, given by way of non-limiting example, in which:

FIG. 1 shows a side section of a suction insect-capturing device equipped with a fan in accordance with the present invention;

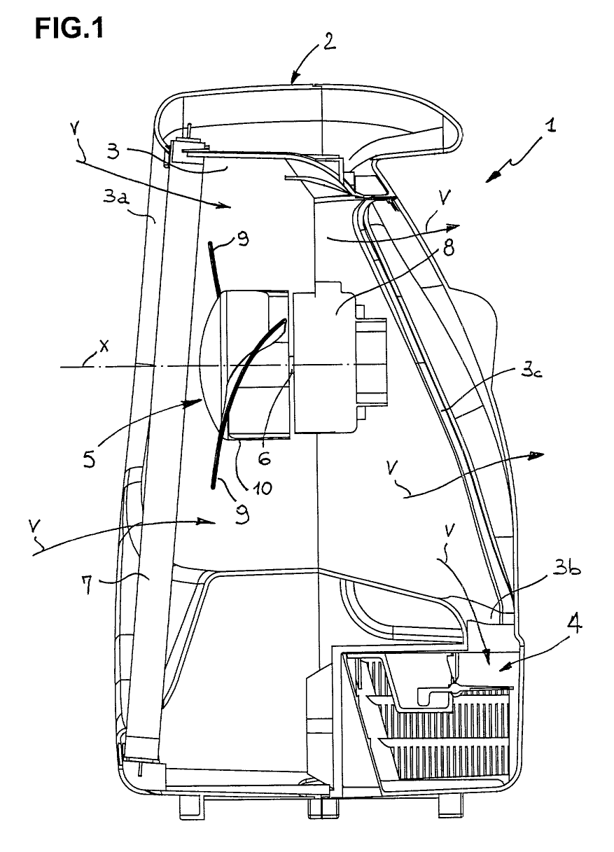

FIG. 2 is a perspective view of the fan in question;

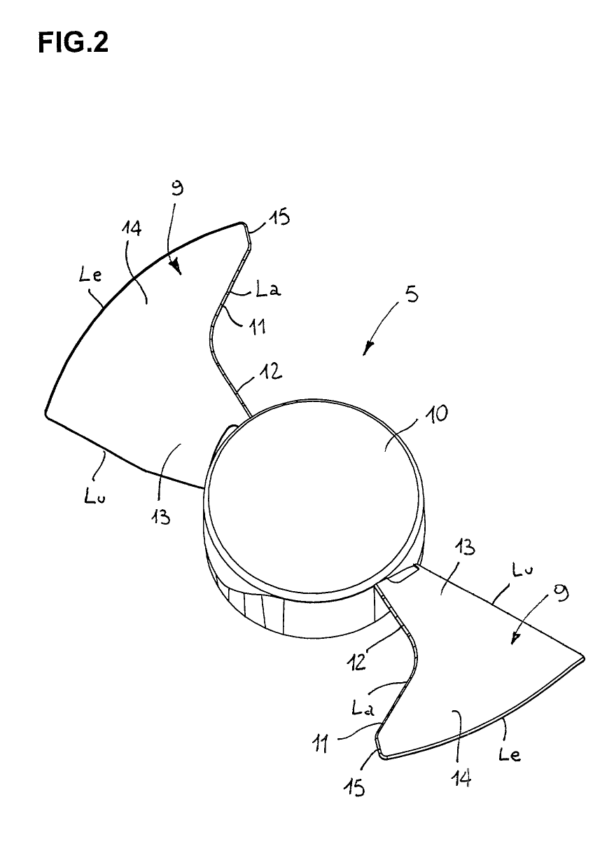

FIG. 3 is a rear view of the fan shown in FIG. 2;

FIG. 4 is a side view of the fan in FIG. 2.

### DESCRIPTION OF THE PREFERRED EMBODIMENT

With reference to the drawings, a suction insect-capturing device equipped with a fan in accordance with the invention is generally denoted by reference numeral 1.

Device 1 comprises a holding structure 2 inside which a sucking duct 3 is housed which at one end 3a is open to the outside and at the opposite end 3b communicates with a collecting vessel 4.

Within the sucking duct 3, close to the open end 3a, there is a fan 5 mounted on a rotating shaft 6 coaxial with the sucking duct 3. The fan generates an air flow V from the open end 3a to the collecting vessel 4 which is located downstream of the fan 5 itself. At the front of fan 5 a lamp 7 may be placed the light of which serves to attract insects to the operating region of the air flow V. Preferably, duct 3 has a funnel-shaped conformation, with a decreasing section from the open end 3a to vessel 4.

A wall of duct 3 downstream of fan 5 has a grating 3c through which part of the incoming air is discharged while the rest of the air flow carries the insects to vessel 4.

Fan 5 is maintained in rotation by a motor 8, preferably having a maximum electrical input not exceeding 2 watts, which is operatively connected to shaft 6.

In more detail, fan 5 comprises at least one blade 9 of plastic material, preferably low-density polyethylene or other appropriate elastomer material, extending radially away from a hub 10 to be coaxially mounted on shaft 6 of device 1. In the embodiment shown fan 5 comprises two radially opposite blades 9.

Blades 9 rotate about the axis of shaft 6 which is coincident with the axis of hub 10 that hereinafter will be merely identified as rotation axis X.

Each blade 9 is mounted on hub 10 so as to form a setting angle β relative to a plane perpendicular to the rotation axis X. For clarity purposes it is pointed out that in the following of the present description it is defined as the profile of a blade of a rotor, to a given distance from the rotation axis X, the blade section according to a cylindrical surface of same radius as the length of said distance and coaxial with the rotor, developed on a plane.

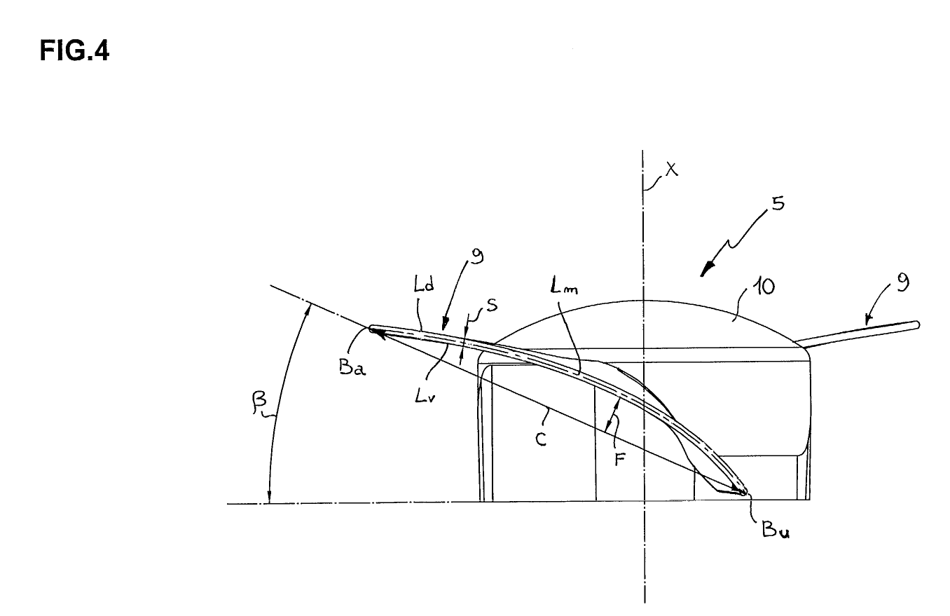

With particular reference to FIG. 4, each profile has a dorsal line Ld, a ventral line Lv, a leading edge Ba, facing the rotation direction of the rotor, and a trailing edge Bu facing away from the rotation axis.

In addition, a median line Lm is identifiable, which is defined as the location of the middle points between the dorsal line Ld and ventral line Lv, and a chord “c” defined as a straight line joining the leading edge Ba to the trailing edge Bu. Arrow “f” of the profile is the maximum distance of the median line Lm from the chord “c”.

Finally, identified as the leading flap La of blade 9 is the location of the leading edges Ba of the profiles P of blade 9 and as the trailing flap Lu the location of the trailing edges Bu of the profiles P of blade 9.

In order that device 1 may operate as a vacuum device, fan 5 is mounted on shaft 6 of device 1 in such a manner that the leading flap La of blade 9 is axially more forward towards the open end 3a of duct 3 than the trailing flap Lu. In this manner rotation of fan 5 generates a fluid stream V from the open end 3a to the collecting vessel 4.

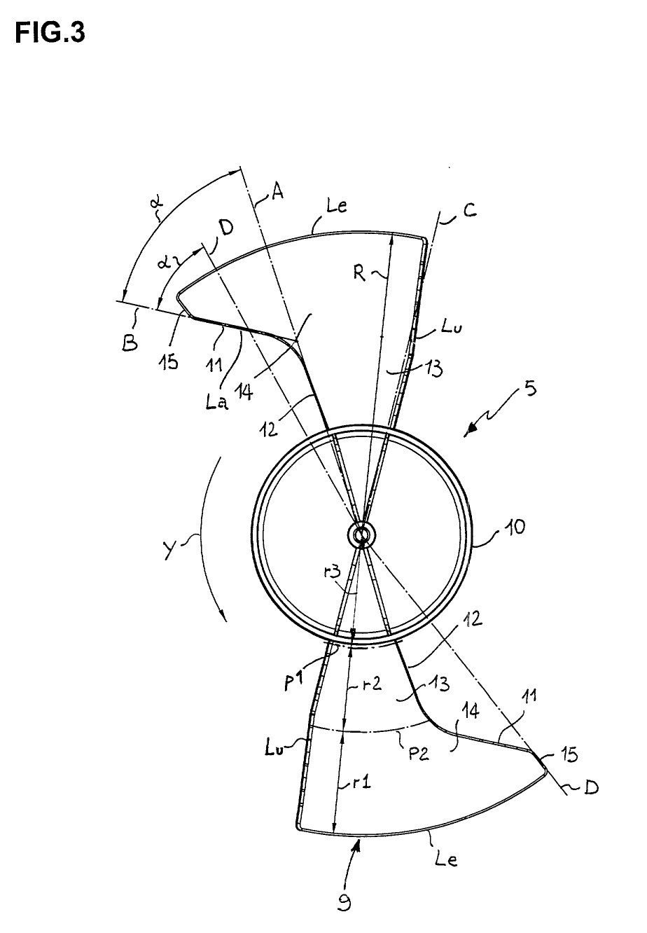

Advantageously, the leading flap La of each blade 9 is angularly offset, at least at a radially external portion 11 thereof, in the rotation direction Y of fan 5, with respect to radial directions D (one of which is shown, by way of example, in FIG. 3) extending from the rotation axis X and intersecting said leading flap La. In other words (FIG. 3), taking into consideration a straight line passing through the rotation axis X lying in the rotation plane of fan 5 and intersecting the leading flap La, it is possible to see how at each intersecting point the leading flap La is rotated, relative to said straight line, through an angle α in the same way as the rotation direction Y of fan 5 during its operation.

Preferably, at least at the radially external portion 11 of the leading flap La, angle α is at least 30° and preferably is included between 40° and 60°.

According to the preferred embodiment herein shown, the leading flap La of each blade 9 further has a radially internal portion 12 substantially lying on a first straight line A which is coincident with a direction radial to the rotation axis X. The radially external portion 11 preferably lies on a second straight line B angularly offset in the rotation direction Y of fan 5, relative to the first straight line A, to form said angle α.

The embodiment illustrated in the accompanying drawings further shows that the trailing flap Lu of each blade 9 substantially lies on a third straight line C which too is coincident with a direction radial to the rotation axis X.

In blade 9 therefore, two distinct parts can be identified, i.e. a first radially-internal part 13 which is associated with the radially internal portion 12 of the leading flap La, and a second radially-external part 14 which is associated with the radially external portion 11 of the leading flap La.

The first part 13 of blade 9 therefore has a substantially trapezoidal shape in plan view (FIG. 3) and is defined between a radially internal profile p1 and an intermediate profile p2, located at a first radial distance r2 from the radially internal profile p1.

The second part 14 too has a substantially trapezoidal shape in plan view and is defined between the intermediate profile p2 and an end flap Le, located at a second radial distance r1 from the intermediate profile p2.

The end flap Le is preferably connected to the leading flap La through a short intermediate stretch 15 which too lies in a direction radial to the rotation axis X.

More specifically, the end flap Le has the shape of an arc of a circle of radius R corresponding to the length of blade 9 measured from the rotation axis X. In this manner the shape of the end flap Le of the blade matches that of the inner wall of duct 3 the radial size of which, in the section in which fan 5 is mounted, is only slightly bigger than the length of the blade 1 itself.

Preferably, each profile of blade 9 has a constant thickness “s” and the median line Lm of each profile is a curved line; the leading edge Ba of each profile is rounded. In addition, blade 9 is preferably warped so that the setting angle β of the profiles decreases on radially moving away from the rotation axis X. Advantageously, the ratio of the radial extension r2 of the first part 13 of blade 9 to the radial extension r1 of the second part 14 of blade 9 is included between 0.5 and 2 and preferably corresponds to 1. In addition, the radially internal profile p1 preferably has a chord corresponding to about ¼ of the length R of blade 9.

Furthermore, the ratio between arrow “f” and chord “c” of the profile of blade 9 at the end flap Le is included between 1/12 and ⅛. Finally, blade 9 has a thickness “s” at the end flap Le included between 1/60 and 1/40 of the respective chord c.

Operation of the fan of the present invention described above mainly as regards structure, is as follows.

The air flow generated by fan 5 captures all insects that are in the vicinity of device 1 and carries them along into duct 3 towards the collecting vessel 4. The peripheral linear speed of fan 5, of 10-15 m/s for example and at all events preferably close to the maximum value allowed by the safety regulations, is much higher than the speed of the insect carried along and even if most insects pass through the region of concern of fan 5 unhurt, some of them are intercepted by the leading flap La and bounce thereon. The impact speed of the insect on the leading flap La is substantially the same as the linear speed of blade 9 at the impact point because the speed component of the insect in the rotation plane of blade 9 can be considered as negligible. The impact direction is substantially perpendicular to the radial direction passing through the impact point.

Insects hitting blade 9 at the radially internal portion 12 of the leading flap La bounce back with a speed slow enough to enable them to be at all events sucked; insects hitting blade 9 at the radially external portion 11 of the leading flap La, due to the inclination of said portion 11, are directed towards the central region and similarly sucked in.

The invention achieves important advantages.

First of all the fan in accordance with the present invention enables possible insects impacting thereon to be addressed to a region where the air flow impinges on them in an efficient manner and sucks them in, avoiding the same being crushed on the duct walls.

In fact, in particular, the shape of the radially external portions of the leading edge offers an impact surface facing the fan centre and ensures that the direction in which an insect bounces is exactly turned towards the centre itself.

The radius between the end flap Le and the leading flap La ensures more safety should a person, in particular a child, get accidentally in contact with the flap itself. Finally, the particular geometry of the blades promotes deformation of same, due to the aerodynamic and centrifugal forces giving rise to such a variation in the flow conditions that an aerodynamic-drag increase counteracting the fan rotation is caused. In fact, due to the torsional flexibility of the blade, in particular in the radially outermost portion thereof, during rotation the leading flap La moves axially, reaching displacement values up to 3-5 mm and causing an increase in the setting angle β and a consequent increase in the aerodynamic drag. Therefore, if under the effect of possible temporary increases or excess oscillations in the power supplied to the shaft by the motor, the fan begins rotating beyond a given speed, the automatic increase in its aerodynamic drag causes slowing down of same. Therefore, adopting the fan of the invention makes it superfluous to use expensive motors ensuring minimum oscillations in the supplied-power values.

It should be also recognized that the concerned fan enables creation, in the sucking duct 3, of an air flow of higher speed than the speed obtainable from known fans, even if the rotation speed is maintained to lower values than the maximum values allowed by regulations.

The device as conceived is susceptible of many modifications and variations, all of them falling within the inventive idea characterizing it. All of the details can be replaced by technically equivalent elements and practically the materials used and the sizes can be of any nature depending on requirements.

What is claimed is:

1. A fan for suction insect-capturing devices, comprising:
at least one blade (9) extending radially away from a hub (10) mountable on a rotation shaft (6) of a suction insect-capturing device (1), to rotate about a rotation axis (X) coincident with the hub axis, and defining at least one setting angle (β) relative to a plane perpendicular to the rotation axis (X);
characterized in that said at least one blade (9) has a leading flap (La) angularly offset, at least at a radially external portion (11), in the rotation direction of the fan (Y), relative to radial directions (D) extending from the rotation axis (X) and intersecting said leading flap (La).

2. A fan as claimed in claim 1, wherein the leading flap (La) is angularly offset by an angle of at least 30°.

3. A fan as claimed in claim 1, wherein the leading flap (La) is angularly offset by an angle included between 40° and 60°.

4. A fan as claimed in claim 1, wherein the leading flap (La) of said at least one blade (5) has a radially internal portion (12) substantially lying in a radial direction (D) to the rotation axis (X).

5. A fan as claimed in claim 1, wherein the trailing flap (Lu) of the blade (9) substantially lies in a radial direction (D) to the rotation axis (X).

6. A fan as claimed in claim 1, wherein said fan comprises two radially opposite blades (9).

7. A blade as claimed in claim 1, wherein the blade (9) has an end flap (Le) connected to the leading flap (La) through an intermediate stretch (15) lying in a radial direction (D) to the rotation axis (X).

8. A fan as claimed in claim 1, wherein the leading flap (La) seen in cross section has a rounded shape.

9. A fan as claimed in claim 3, wherein the ratio between the radial extension (r2) of a first part (13) of the blade (9) associated with the radially internal portion (12) of the leading flap (La) and the radial extension (r1) of a second part (14) of the blade (9) associated with the radially external portion (11) of the leading flap (La) is included between 0.5 and 2.

10. A fan as claimed in claim 9, wherein the second part (14) of the blade (9) has substantially a trapezoidal shape, seen in plan view.

11. A fan as claimed in claim 1, wherein the blade is in engagement with the hub (10) at a radially internal profile (p1) spaced apart from the rotation axis (X) by a measure (r3) substantially corresponding to ⅓ of the overall length of the blade (R).

12. A fan as claimed in claim 11, wherein the radially internal profile (p1) has a chord substantially corresponding to ¼ of the overall length of the blade (R).

13. A fan as claimed in claim 1, wherein the blade has an end flap (Le) the profile of which has a arrow (f) included between 1/12 and ⅛ of the respective chord (c).

14. A fan as claimed in claim 1, wherein the blade has an end flap (Le) the profile of which has a thickness (s) included between 1/60 and 1/40 of the respective chord (c).

15. A fan as claimed in claim 1, wherein at least said blade (9) is made of an elastomer material.

16. A fan as claimed in claim 1, wherein at least said blade (9) is made of polyethylene.

17. A fan as claimed in claim 1, wherein said at least one blade (9) has a torsional flexibility so as to cause an axial displacement of the leading flap (La) by effect of the fan (5) rotation.

18. A fan as claimed in claim 15, wherein the axial displacement of the leading flap (La) is at least 3 mm.

19. A suction insect-capturing device, comprising:
a sucking duct (3);
a rotating shaft (6) coaxially mounted in the sucking duct (3);
a fan (5) mounted on the shaft (6);
a motor (8) operatively connected to the shaft (6) to keep the fan (5) in rotation;
a collecting vessel (4) communicating with the sucking duct (3) and located downstream of the fan (5);
characterized in that the fan (5) is made in accordance with anyone of claims 1 to 18.
